(19) United States
(12) Patent Application Publication
(10) Pub. No.: US 2023/0184341 A1
(43) Pub. Date: Jun. 15, 2023

(54) DIVERSION DEVICE, SERIES OF DIVERSION DEVICES AND USE OF A STANDARD INTERFACE FOR FASTENING DIFFERENT VARIANTS OF DIVERSION DEVICES

(71) Applicant: Neoperl GmbH, Müllheim (DE)

(72) Inventor: Yichao BIAN, Müllheim (DE)

(73) Assignee: Neoperl GmbH, Müllheim (DE)

(21) Appl. No.: 17/917,066

(22) PCT Filed: Mar. 19, 2021
(86) PCT No.: PCT/EP2021/057131

§ 371 Date: Oct. 5, 2022

(30) Foreign Application Priority Data
Apr. 9, 2020 (DE) 20 2020 101 990.2

(51) Int. Cl. F16K 11/044; F16K 27/02; F16K 31/56

(52) U.S. Cl. CPC F16K 11/0445; F16K 27/0263; F16K 31/566; E03C 2201/30

(57) ABSTRACT

A diversion device (1), in particular for a sanitary fitting (100), including a housing (2) which forms a valve body space (23) with at least one inlet opening (3) and at least two outlet openings (4, 5). A valve body (6) is guided in an adjustable manner within the valve body space (23) and can be used to divert a flow path (7, 8) between the at least two outlet openings (4, 5), the valve body (6) can be adjusted by an adjustment mechanism (9), the adjustment mechanism (9) is operatively connected to an operating element configured as a push-button (10), and an operative connection can be established between the adjustment mechanism and the push-button.

### INCORPORATION BY REFERENCE

The following documents are incorporated herein by reference as if fully set forth: PCT Application No. PCT/EP2021/057131, filed Mar. 19, 2021; and German Patent Application No. 20 2020 101 990.2, filed Apr. 9, 2020.

### TECHNICAL FIELD

The invention relates to a diversion apparatus, in particular for a sanitary fitting, comprising a housing having at least one inlet opening and at least two outlet openings, a valve body, by means of which a throughflow path between the at least two outlet openings can be diverted, wherein the valve body can be adjusted by means of an adjustment mechanism.

The invention further relates to a series of diversion apparatuses.

Finally, the invention relates to the use of a uniform interface for securing different variants of diversion apparatuses.

### BACKGROUND

Diversion apparatuses of the type mentioned in the introduction are already known and are used, for example, in sanitary installations, in particular in sanitary fittings in order to be able to redirect a fluid which flows into the diversion apparatus between different throughflow paths. For example, using a diversion apparatus a diversion between a throughflow path which is associated with a hand shower and/or a throughflow path which is associated with a head shower and/or a throughflow path which is associated with a bathtub inlet can be carried out.

EP 1 281 899 A2 discloses a switching device for a sanitary facility with at least two water consumers, with a valve body of the switching valve device being a control disc which has at least one water passage opening and can be rotated against a fixed base plate which has at least two water passage openings that communicate with the outlets of a housing.

ES 2182635 A1 has disclosed a water-distribution valve for a bath and for shower fittings, wherein a shank is provided with a lower cylindrical cavity, which is open at the top and at the bottom and whose inner cavity defines an opening connecting a common entry line downward to an exit line of a shower, and wherein a closure means connected fixedly to a rod, which rod is pushed upward by an extension spring that is actuated by a push-button, consists of an annular projection which surrounds the upper edge of the lower part or of the hollow cylinder at the outside and which is configured such that it can be inserted into two circumferential seats in which a fixed part of a cartridge is provided.

DE 38 36 352 A1 has disclosed an automatic switchover means for a mixer faucet in sanitary fittings, in the case of which an actuating mechanism for position switching and an actual switchover mechanism have parts which are independent of one another and which consist substantially of a push-button which extends inward with its shank, wherein the shank, under pressure, acts on and actuates the switchover mechanism, while the push-button is provided with a return spring, which resets the button into its initial position again as soon a hand pressure decreases, without the appearance of the fitting being changed in this way.

US 2012/012676 A1 has disclosed a handheld water-discharge apparatus which contains a housing, a water-supply tube fastened in the housing, a valve holder and a discharge arrangement, wherein the valve holder has an inlet space, a distribution space, a peripheral flowing space, a central flowing space and a groove; the distribution space contains a multiplicity of ratchet blocks; the outlet arrangement is fixed to the groove and comprises a first outflow element and a second outflow element; a valve insert is displaced in the distribution space and comprises a first closing segment; a resilient element is used to push the valve insert downward; a positioning element is fastened in the distribution space and comprises a preloading portion, a number of engagement teeth, and a shank; a button element serves for correctly pushing the positioning element upward.

US 2020/078800 A1 has disclosed a switching apparatus which comprises a T-piece and a switching lever. A switching chamber is situated in the T-piece. The switching chamber is provided with a water inlet and a multiplicity of water outlets. The switching lever is provided with a water-stop part. The switching lever can be moved in order for the position of the water-stop part between the water inlet and the water outlets to be changed so as to realize the switchover of the water passage.

DE 20 2011 101 289 U1 has disclosed a diversion valve having a valve housing which has an inlet opening and three outlet openings, of which, by means of a diversion shaft guided displaceably in the valve housing, in each case one outlet opening can be selectively assigned to the inlet opening, having two sealing elements, which are guided displaceably on the diversion shaft between two drivers and are kept at a distance from one another with the aid of at least one thrust element, having a switching tube which is guided displaceably in the valve housing via two circumferential guide-ring surfaces provided on the tube circumference thereof and which has at least one radial switching-tube opening provided between the guide-ring surfaces, wherein an axial setting movement of the diversion shaft can be transmitted in such a way at least to one of the two sealing elements that either both sealing elements bear with outer circumferential sealing surfaces against counterpart sealing surfaces, bordering a fluid passage, of the valve housing and one of the sealing elements, by way of an inner circumferential sealing surface, closes off the adjacent circumferential face edge of the switching tube while the other sealing element remains at a distance from the other circumferential face edge, serving as a fluid passage, of the switching tube, or else both inner circumferential sealing surfaces of the sealing elements bear against the adjacent circumferential edges of the switching tube while one sealing element, by way of its outer circumferential sealing surface, acts on the adjacent counterpart sealing surface which borders the fluid passage and the other sealing element is spaced apart from the counterpart sealing surface which is assigned thereto and which borders a fluid passage.

CN 205 036 896 U presents a further example of a diversion apparatus.

However, many users find the operation of previously known diversion apparatuses to be uncomfortable and/or cumbersome.

### SUMMARY

The object is consequently to provide a technical solution with improved properties for use.

This object is achieved according to the invention by one or more aspects of subject-matter disclosed herein.

In particular according to the invention, in order to achieve the objective a diversion apparatus of the type mentioned in the introduction is proposed, wherein the adjustment mechanism is operationally connected to an operating element which is in the form of a push-button and/or in that an active connection can be configured between the adjustment mechanism and the push-button.

This has the advantage that a more comfortable capacity for operation of the diversion apparatus is possible, in particular by the user being able to carry out the adjustment between a first and a second throughflow path simply by pressing the push-button. An adjustment by applying a tensile force to a manual operating element, as required in conventional diversion apparatuses, can preferably be dispensed with.

Advantageous embodiments of the invention which can be combined alone or in combination with the features of other embodiments optionally together with the features noted above will be described below.

According to an advantageous development, there may be provision for the push-button to be initially uncoupled from the adjustment mechanism and/or from a control element during a switching operation and to be subsequently coupled to the adjustment mechanism and/or the control element. Consequently, it is possible to uncouple the push-button at least temporarily from the adjustment mechanism in order not to transmit forces acting on the adjustment mechanism to the push-button. Preferably, in the uncoupled state, a relative adjustment between the push-button and the control element may be possible.

According to another embodiment, there may be provision for the push-button to be securely connected to the adjustment mechanism and/or a control element. Consequently, a structural complexity can be reduced.

In this instance, for example, there may be provision for the push-button to be rigidly connected to the valve body. Consequently, a switching state of the valve body can be read with reference to a switching position of the push-button.

According to another advantageous embodiment, the adjustment mechanism can be configured for a monostable adjustment of the valve body. In particular, the adjustment mechanism may be configured in such a manner that, with a pressure acting on the inlet opening, a stable adjustment of the valve body from the first position into the second position is possible so that the valve body remains in the second position when pressure is applied. In the event of a pressure decrease at the inlet opening, a return of the valve body from the second position into the first position may occur. This is advantageous, for example, if water is intended to be prevented from being inadvertently discharged from a shower outlet when the fitting is opened. Furthermore, a shower hose which is located in a bathtub which is full can be reliably prevented from emptying the bathtub as a result of a pressure decrease in the water pipe system.

According to another advantageous embodiment, the adjustment mechanism may be configured for a bistable adjustment of the valve body. In particular, the adjustment mechanism may be configured in such a manner that, regardless of a pressure acting at the inlet opening, the valve body can be adjusted in a stable manner in a desired position of at least two positions, in particular into a position which is associated with a throughflow path in each case. This configuration has the advantage that, regardless of a pressure applied at the inlet opening, a stable adjustment to a throughflow path is possible. For example, it is thus possible to prevent water from running out via a bath tub inlet when the fitting is opened, wherein a showering shower is actually intended to be supplied. As a result of a bistable diversion apparatus, a stable throughflow path adjustment can thus be carried out regardless of pressure.

According to an advantageous development, there may be provision for the push-button to be extended in the first position and pressed-in in the second position. Alternatively or additionally there may be provision by applying a pressing force to the push-button for a diversion of the valve body at least from a first position into a second position to be possible. It may be particularly advantageous if a return from a second position into a first position is also carried out by a pressure activation of the push-button, preferably when the diversion apparatus is constructed in a bistable manner. This embodiment is described in greater detail below.

In order to be able to achieve a return of the push-button and/or the control element and/or the valve body, according to an advantageous embodiment there may be provision for the diversion apparatus to have at least one return element which is arranged in such a manner that a restoring force which can thereby be produced counteracts a pressure activation of the push-button. In particular, the return element may be compressed in the second, pressed-in position of the push-button. The push-button may in particular be able to be adjusted relative to the housing.

In order to prevent the push-button and/or the control element and/or the valve body from springing back, the diversion apparatus may have at least one damping element, which can produce a damping force which, when the valve body is returned from the second position into the first position, counteracts an adjustment force, in particular the restoring force which can be produced by means of the return element, and/or which acts in the pressing force which can be applied by means of the push-button. Preferably, as a result of the return element, alternatively or additionally a sealing element may be acted on in order to retain it at the intended location thereof. Consequently, the damping element may have a dual function. It may be particularly advantageous for the damping element to be in the form of a spring, in particular a conical and/or funnel-like spring.

In an advantageous embodiment, in particular with a monostable diversion apparatus, there may be provision for the diversion apparatus to have at least one damping unit by means of which an adjustment movement of the valve body from the first position (or a rest position) into the second position (or a deflected position) can be damped. Consequently, pressure surges which may occur in an uncontrollable path portion per se at the end of an adjustment path can be reduced or prevented.

In this instance, there may be provision for the damping unit to have a flow obstacle, preferably in an opening pressure chamber. Consequently, an operating pressure can be used for damping. It is consequently possible to configure the damping to be more powerful, the greater the operating pressure is.

In order to enable a leakage-free diversion between the at least two throughflow paths, the valve body may separate a first throughflow chamber from a second throughflow chamber. In particular in the first position, the first throughflow chamber may be connected to the inlet opening and, in the second position, the second throughflow chamber may be connected to the inlet opening. Preferably, a separation can be configured by means of at least one sealing element. It is consequently possible to prevent a fluid flow between the throughflow chambers.

In one embodiment of the invention, there may be provision for a first throughflow chamber, for example, the throughflow chamber which has already been mentioned, to be limited by the valve body in the adjustment direction thereof by means of impact surfaces of different sizes. Consequently, a switching position which can be retained by means of an operating pressure can be defined. It is advantageous for the surface contents to be configured in such a manner that the first throughflow chamber is kept open by means of an operating pressure. Consequently, it is possible to remain in the switching position as long as the operating pressure does not decrease. It is advantageous for this to be carried out counter to a restoring force of a return element, for example, the return element which has already been mentioned. Consequently, an automatic return into an initial state when the operating pressure decreases may be able to be achieved.

In one embodiment of the invention, there may be provision for a second throughflow chamber, for example, the throughflow chamber which has already been mentioned, to be limited by the valve body in the adjustment direction thereof by impact surfaces substantially of the same size. Consequently, an actuation, in particular movement into the or an unstable switching position, is possible even at high pressures with little application of force. It is advantageous for a resultant application of operating pressure to the valve body to be smaller than a restoring force of a return element, in particular the one already mentioned.

According to a development, there may be provision for the valve body to be able to be engaged in a stable manner in the first and in the second position by means of the adjustment mechanism. The adjustment mechanism may consequently have a locking mechanism. Alternatively or additionally, there may be provision for the adjustment mechanism to be in the form of a push-push adjustment mechanism. A push-push adjustment mechanism may be understood to be an adjustment mechanism which — in the same manner, for example, as a ballpoint pen adjustment mechanism - can be controlled exclusively by pressing the push-button. Consequently, a particularly comfortable adjustment of the diversion apparatus can be achieved since it is generally simpler to carry out an adjustment by applying a pressing force than by applying a tensile force.

There may be provision in this instance for the adjustment mechanism to have a rotating switching element. The haptic feel of a ballpoint pen adjustment mechanism can thereby be produced. A haptic response with regard to a successful activation is consequently possible. In this instance, the switching element can cooperate alternately with guide paths of different lengths in order to define different positions of the adjustment mechanism, or the switching element may cooperate with guide paths of the same length in order to define only one stable position of the adjustment mechanism.

A simplified adjustment mechanism may also be provided, in which no switching element is provided. Consequently, rotating components in the adjustment mechanism can be dispensed with.

In one embodiment of the invention, there may be provision for the adjustment mechanism to have a stable switching position and an unstable switching position. Consequently, an automatic return into a starting position is possible. It is possible to prevent the diversion apparatus from remaining in an undesirable state in an incorrect or undetected manner.

In this instance, there may be provision for a return element, for example, the return element which has already been mentioned to be moved from the unstable switching position to the stable switching position. Consequently, the stable switching position at the same time defines a rest position.

According to a particularly advantageous embodiment, there may be provision for the valve body to be operationally connected to the push-button by means of a control element, in particular wherein the valve body and the control element are constructed in one piece.

The object mentioned in the introduction is preferably further achieved by a series of diversion apparatuses, having at least one monostable variant which forms a monostable diversion apparatus, in particular as described and/or claimed herein, and at least one bistable variant which forms a bistable diversion apparatus, in particular as described and/or claimed herein. In particular, the monostable variant and the bistable variant may define and/or have a uniform mechanical interface for a receiving sanitary fitting.

According to an alternative or additional solution, according to the invention a series of diversion apparatuses is proposed, having at least one long variant which forms a monostable diversion apparatus, in particular as described and/or claimed herein, and at least one short variant which forms a monostable diversion apparatus, in particular as described and/or claimed herein, wherein the long variant and the short variant define a uniform mechanical interface for a receiving sanitary fitting and, in the long variant, a portion which protrudes over the interface is larger than in the short variant.

According to an advantageous development, there may be provision for the short variant to be identical to the monostable variant and/or, in the long variant, the portion which protrudes over the interface to be of the same size as the corresponding portion in the bistable variant.

The invention additionally relates to the use of a uniform interface for securing different variants of diversion apparatuses as described and/or claimed herein to a sanitary fitting.

The invention further relates to a series, as described and/or claimed herein, wherein the at least two diversion apparatuses have structurally identical coupling locations in order to be able to be selectively coupled to a corresponding counter-coupling location of a fitting.

### BRIEF DESCRIPTION 0 FTHE DRAWINGS

The invention will now be described in greater detail with reference to a plurality of embodiments, but is not limited to these embodiments. Other embodiments will be appreciated from the combination of the features of individual or a plurality of claims with each other and/or with individual or several features of the embodiments.

In the drawings:

FIGS. 1-5 show a first possible variant (long variant) of a diversion apparatus according to the invention as different views which has a monostable adjustment mechanism,

FIGS. 6-10 show a second possible variant (short variant) of a diversion apparatus according to the invention as different views which has a monostable adjustment mechanism and which is constructed to be shorter than the variant according to FIGS. 1-5,

FIGS. 11-15 show a third possible variant of a diversion apparatus according to the invention, as different views, which has a bistable adjustment mechanism, and

FIGS. 16-21 show a fourth possible variant of a diversion apparatus according to the invention, as different views, which has a simplified adjustment mechanism.

### DETAILED DESCRIPTION

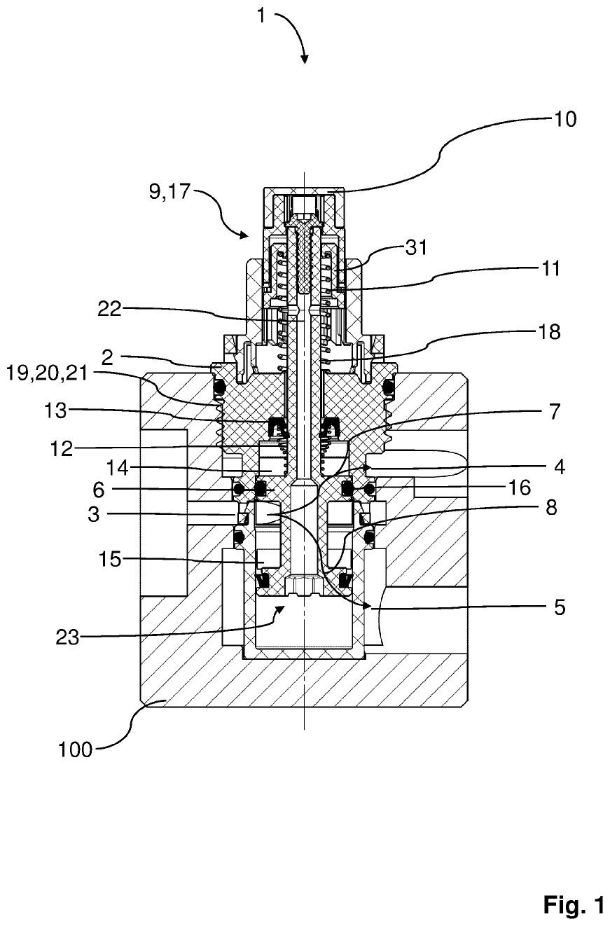

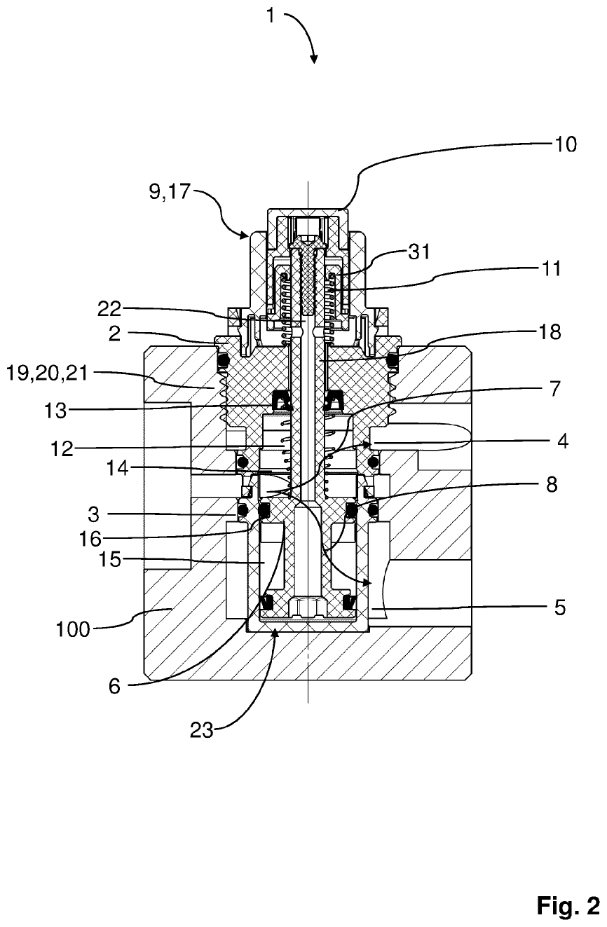

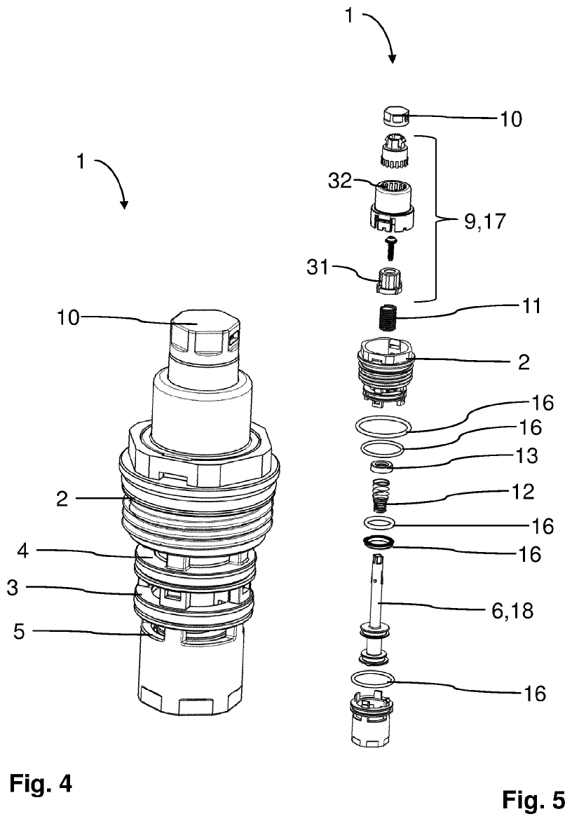

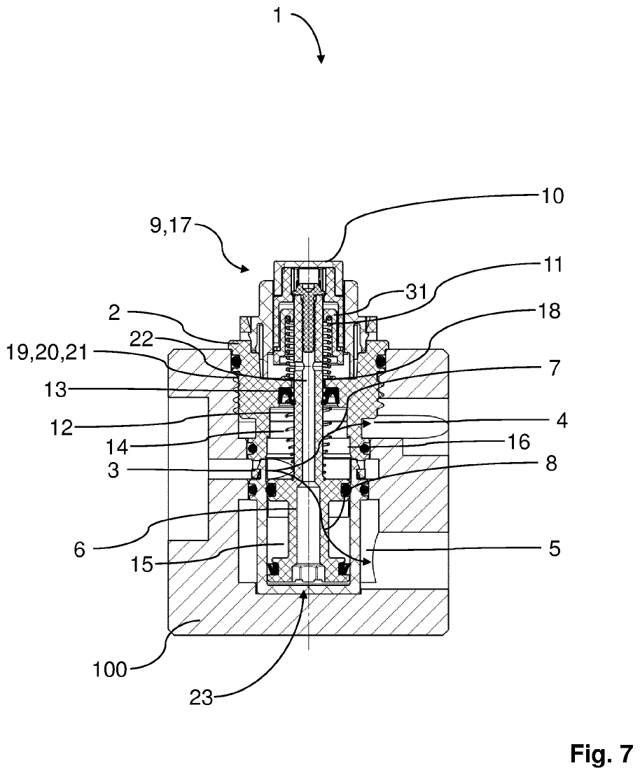

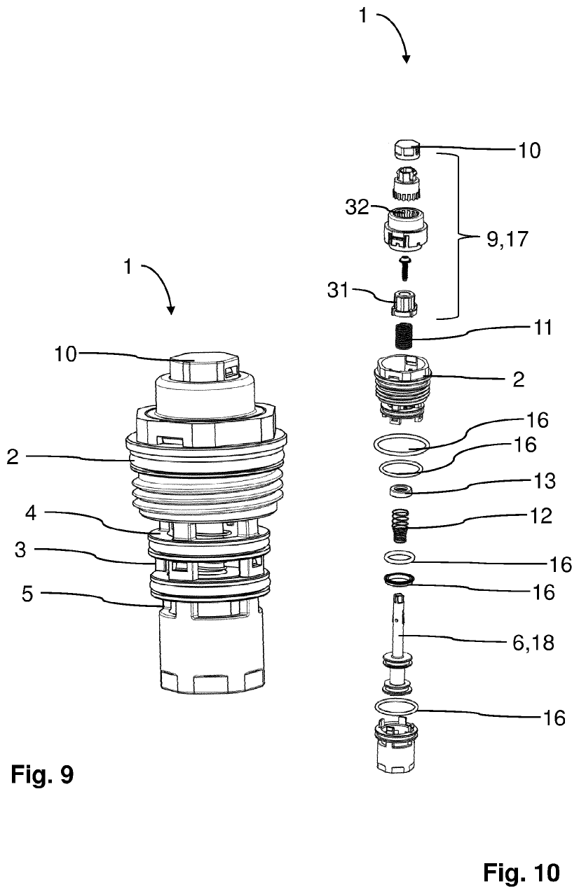

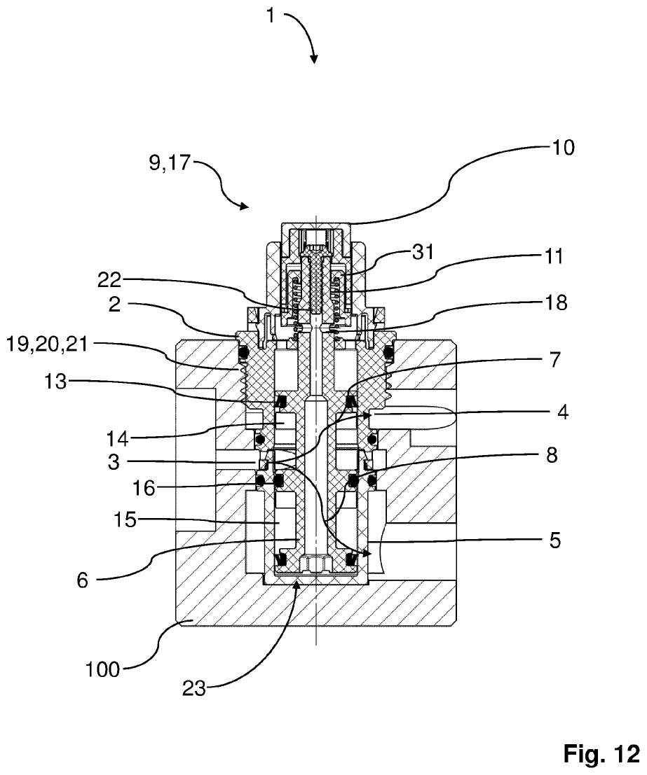

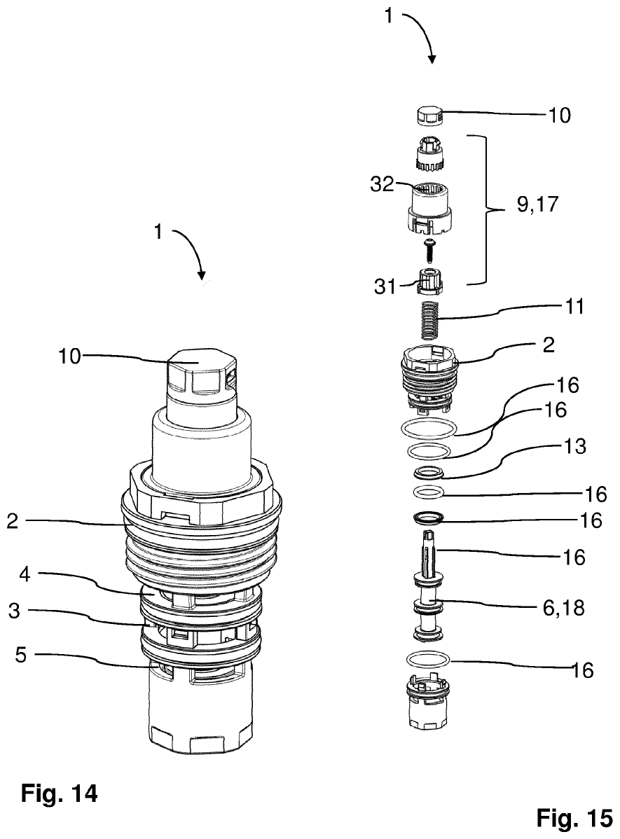

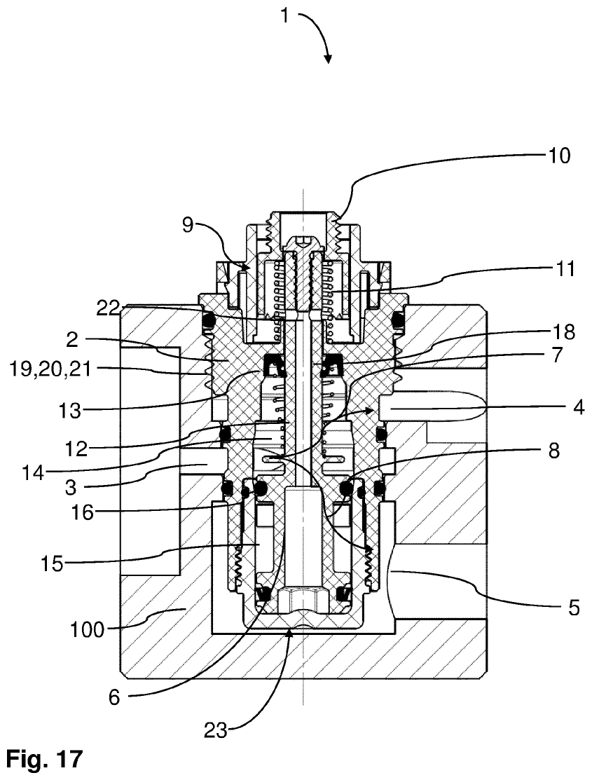

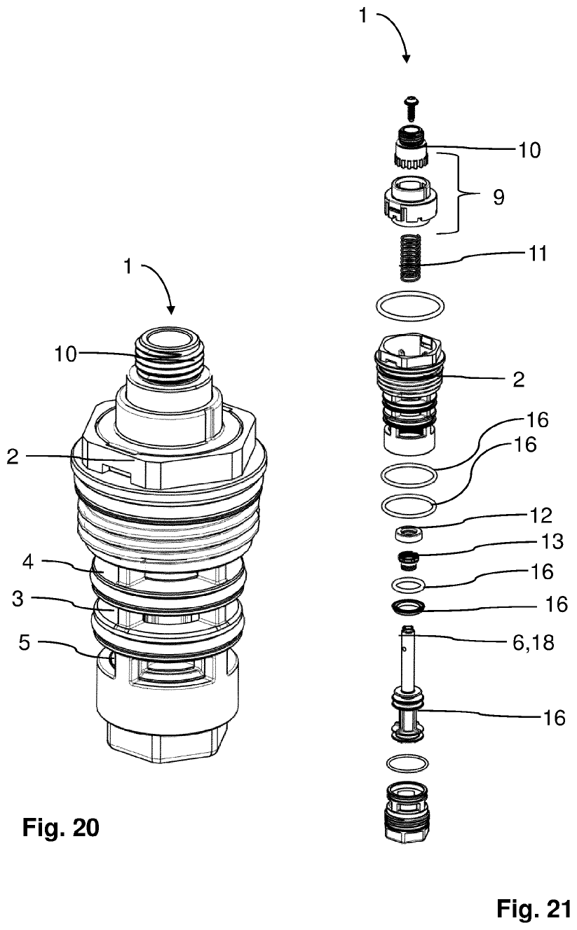

FIGS. 1-21 illustrate four possible embodiments of a diversion apparatus which are generally designated 1 in each case.

The diversion apparatus 1 is configured to be used in a sanitary fitting 100 so that by means of the diversion apparatus 1 a fluid line can be diverted between at least two throughflow paths.

The diversion apparatus 1 comprises a housing 2 which has an inlet opening 3 and at least a first outlet opening 4 and a second outlet opening 5. An adjustable valve body 6 is arranged within the housing 2. As a result of an adjustment of the valve body 6, it is possible to direct the above-mentioned fluid line via a first throughflow path 7 or a second throughflow path 8, wherein in particular fluid can be discharged from only one of the two outlet openings 4, 5 in each case and/or fluid is not discharged from both outlet openings 4, 5 at the same time.

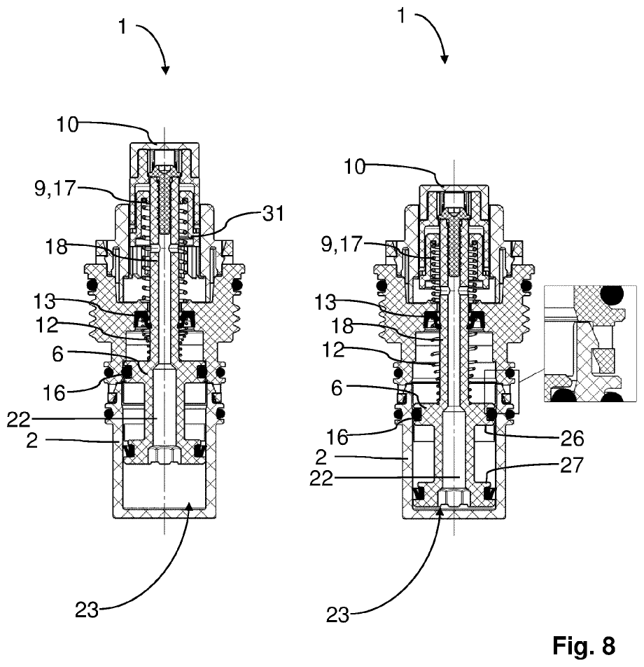

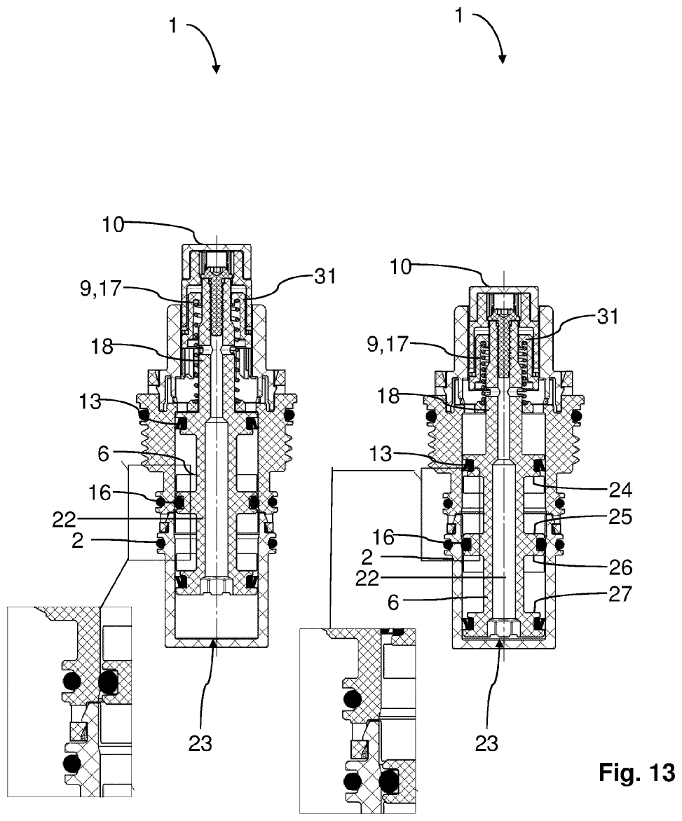

The detailed views in FIGS. 8 and 13 show that the housing 2 is constructed in two pieces for technical production reasons.

The adjustment of the valve body 6 is carried out by means of an adjustment mechanism 9, by means of which a force transmission to the valve body 6 is possible by the mechanism being activated.

In order to activate the adjustment mechanism 9, the diversion apparatus 1 has a push-button 10. A user, by pressing the push-button 10, that is to say, by applying a pressing force, can carry out an adjustment of the valve body 6 from a first position into a second position and/or from a second position into a first position (depending on whether it is a monostable or a bistable version).

With the adjustment mechanism 9, the push-button 10 can consequently be moved into active connection with the adjustment mechanism 9 at least temporarily and/or in at least one adjustment direction.

The push-button 10 consequently does not have to be permanently in an active connection with the adjustment mechanism, but there may be provision for the push-button 10 to initially be uncoupled from the adjustment mechanism 9 during a switching operation and subsequently coupled to the adjustment mechanism 9, or vice versa.

The diversion apparatuses 1 shown in FIGS. 1 to 10 are ones with a monostable adjustment mechanism 9. The adjustment mechanism 9 is configured for a monostable adjustment of the valve body 6 so that, in the event of a pressure acting on the inlet opening 3, a stable adjustment of the valve body 6 from the first position into the second position is possible and/or, in the event of a pressure decrease at the inlet opening 3, the valve body 6 is returned from the second position into the first position.

As known in push-push mechanisms per se, the adjustment mechanism 9 has a switching element 31. The switching element 31 rotates with each actuation through a predetermined angle about the axis thereof In this instance, it travels in guide tracks 32 which depending on the desired position may be constructed with different lengths in order to enable a change between different positions. In the embodiment shown, the guide tracks 32 are of the same length so that only one position is defined, but a user perceives the haptic feeling of a push-push mechanism.

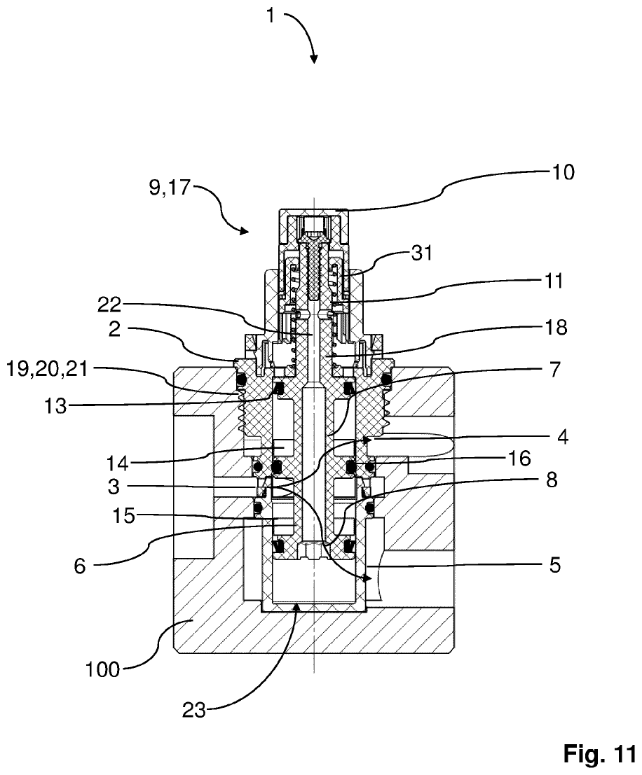

The diversion apparatus 1 shown in FIGS. 11-15 are ones with a bistable adjustment mechanism 9. The adjustment mechanism 9 is configured for a bistable adjustment of the valve body 6 so that the valve body 6 regardless of a pressure acting on the inlet opening 3 can be adjusted in a stable manner in a desired position of at least two positions. It is thus possible to adjust in a stable manner a first throughflow path 7 from the first outlet opening 4 and in a stable manner a second throughflow path 8 from the second outlet opening 5. In the event of a pressure decrease at the inlet opening 3, the valve body 6 remains in the adjusted position thereof

In this instance, the guide tracks mentioned are of different lengths in order to define an upper, first position and a lower, second position. The switching element 31, as a result of the rotational movement mentioned, consequently alternately moves into an operational connection with a long guide path 32 and a short guide path 32.

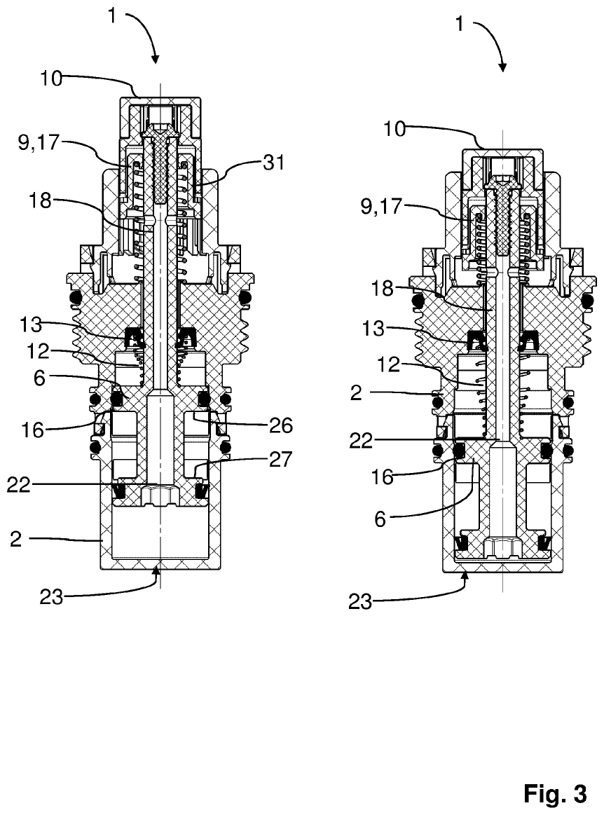

As can be seen in FIGS. 3, 8 and 13, the push-button 10 is extended in the first position and pressed-in in the second position. In the first position, by applying a pressing force to the push-button 10, a diversion of the valve body 6 at least from a first position into a second position can be carried out.

The diversion apparatus 1 comprises at least one return element 11 which is arranged between the push-button 10 and the housing 2, in particular a return element 11 which is supported on the push-button 10 and on the housing 2. As a result of the return element 11, a restoring force which counteracts a pressure activation of the push-button 10 can be produced. The return element 11 may be in the form of a spring so that the return element 11 is compressed in the second, pressed-in position of the push-button 10.

FIGS. 1-10 show two variants of a diversion apparatus 1 which each have at least one damping element 12. The damping element 12 may be configured for one of the two functions described below or for a dual function. The damping element 12 can produce a damping force which in the event of a return of the valve body 6 from the second position into the first position counteracts the adjustment force, in particular the restoring force which can be produced by the return element 11, and/or which acts in the pressing force which can be applied by means of the push-button 10. Alternatively or additionally, there may be provision for a sealing element 13 to be acted on by the damping element 12 in order to retain it at its intended location.

The valve body 6 is arranged so as to be able to be adjusted within a valve body space 23 which is formed by the housing 2. The control element 18 is at the proximal end of the valve body space 23 guided out of the valve body space 23. In order to prevent a discharge of the fluid flowing through the diversion apparatus 1 during use, the outlet location of the control element 18 out of the valve body space 23 is sealed by means of the sealing element 13 mentioned above. The sealing element 13 consequently seals the gap between the control element 18 and an outlet opening from the valve body space 23. The sealing element 13 may, for example, comprise a sealing lip which can be moved relative to the sealing element 13 during a movement of the control element.

The damping element 12 may, for example, be in the form of a spring. The damping element 12 may further be supported on the housing 2 and on the valve body 6. As can be seen in FIGS. 1-10, the damping element 12 may be in the form of a conical spring, particularly wherein the wide end is supported on the housing 2.

The valve body space 23 is subdivided by the valve body 6 into a first throughflow chamber 14 and a second throughflow chamber 15. As a result of an adjustment of the valve body 6 into the first position, the first throughflow chamber 14 is connected to the inlet opening 3. In the second position, the second throughflow chamber 15 is connected to the inlet opening 3. A separation of the two throughflow chambers 14, 15 is carried out by means of at least one sealing element 16 which is preferably arranged on the valve body 6 and which can be adjusted together therewith. As a result of the at least one sealing element 16, it is consequently possible to prevent fluid from passing from one of the two throughflow chambers 14, 15 into the other throughflow chamber 14, 15.

The variant from FIGS. 11-15 is in the form of a bistable diversion apparatus 1. This means that the valve body 6 in the first and second position can be retained in a stable manner in each case by means of the adjustment mechanism 9, in particular can be engaged in a stable manner.

The adjustment mechanisms 9 of the diversion apparatuses shown in FIGS. 1-15 are in each case in the form of a push-push adjustment mechanism 17. This means that an adjustment of the control element 18 and the valve body 6 can be controlled exclusively by pressing the push-button 10.

In order to be able to carry out an adjustment of the control element 18 and the valve body 6, the valve body 6 is operationally connected to the push-button 10 by means of the control element 18. The valve body 6 and the control element 18 are constructed in one piece. However, it is also conceivable for the valve body 6 and the control element 18 to be constructed in two pieces, wherein they are coupled to each other and/or are at least temporarily moved into an operational connection during a switching operation.

In FIGS. 1-15, a series of diversion apparatuses 1 is additionally shown, the at least one monostable variant, for example, according to the two variants from FIGS. 1-10, which has a monostable diversion apparatus 1 and at least one bistable variant which has a bistable diversion apparatus 1, for example, according to the variant from FIGS. 11-15. The monostable variant and the bistable variant are configured for a uniform mechanical interface 19 between the diversion apparatus 1 and a receiving sanitary fitting 100.

The mechanical interface 19 is, on the one hand, formed by means of a coupling location 20 on the diversion apparatus 1 and, on the other hand, by a corresponding counter-coupling location 21 of the sanitary fitting 100.

The at least two diversion apparatuses 1 of the series thus have structurally identical coupling locations 20 in order to selectively be able to be coupled to a corresponding counter-coupling location 21 of a fitting 100.

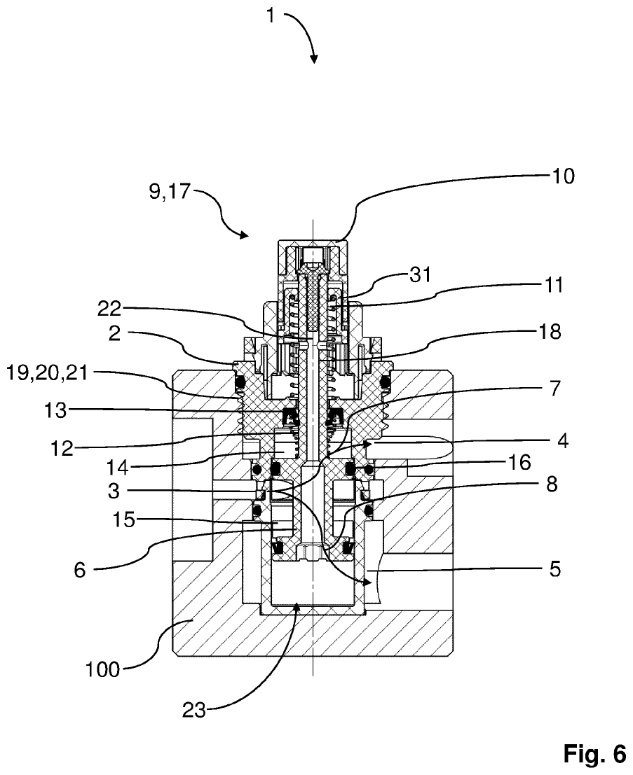

As can be seen in FIGS. 1-10, the series may alternatively or additionally comprise at least one long variant (see FIGS. 1-5) of a monostable diversion apparatus 1 and at least one short variant (see FIGS. 6-10) of a monostable diversion apparatus 1. The long variant and the short variant define a uniform mechanical interface 19 for a receiving sanitary fitting 100, as already explained above. In the long variant, a portion which protrudes over the interface 19 is constructed to be larger than in the short variant. The protruding portion is in the long variant of the same size as the corresponding portion in the bistable variant (cf. FIGS. 11-15).

Consequently, a user can combine the diversion apparatuses 1 of the series in a relatively flexible manner as required with fittings 100 which have corresponding counter-coupling locations without different structural spaces having to be available.

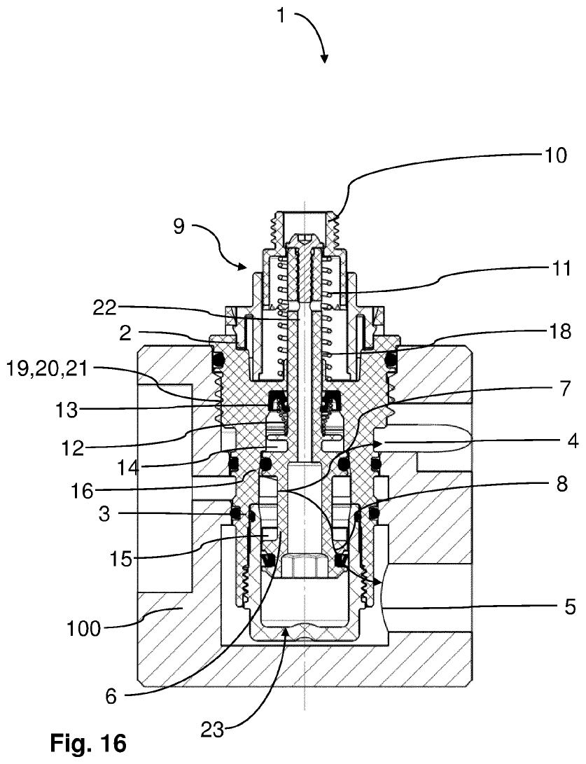

The embodiment according to FIGS. 16 to 21, in which components and functional units which are functionally or structurally similar or identical to the above embodiments are given the same reference numerals and not described separately again, differs from the embodiment according to FIGS. 1 to 10 in that the adjustment mechanism 9 is constructed in a simplified manner.

In this instance, the push-button 10 is guided in a rotationally secure manner in a sleeve 30. At the upper side thereof, an interface for assembling a cover is formed.

The adjustment mechanism 9 consequently comprises in this instance at least the described guide of the push-button 10 and the return element 11.

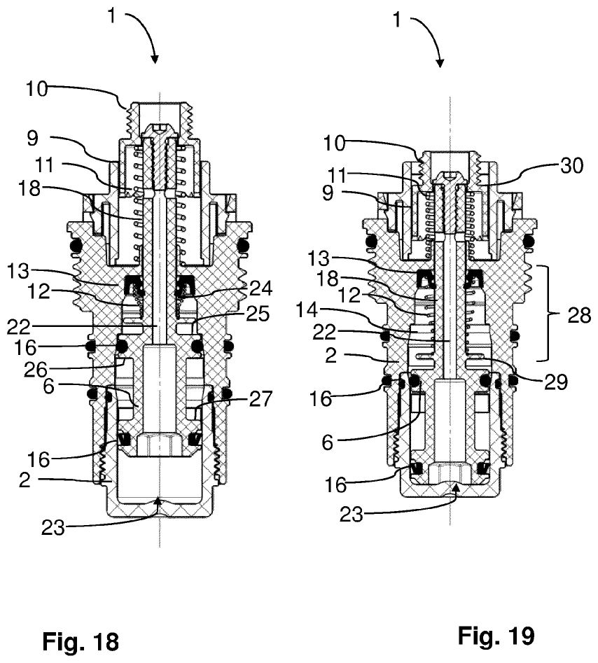

In a similar manner to FIGS. 3 and 8, FIG. 18 shows the stable switching position and FIG. 19 shows the unstable switching position. In the situation of FIG. 19, a pressure decrease at the inlet opening 3 leads to the return element 11 moving the valve body 6 into the switching position according to FIG. 18.

The first throughflow chamber 14 is limited by the valve body 6 in the adjustment direction thereof by means of differently sized impact surfaces 24, 25 on the valve body 6, wherein the impact surface 24 is in this instance practically zero.

It is thereby possible for the first throughflow chamber 14 to be kept open by means of an operating pressure counter to a restoring force of the return element 11.

The second throughflow chamber 15 is limited by the valve body 6 in the adjustment direction thereof by means of impact surfaces 26, 27 which are substantially of the same size on the valve body 6.

This results in the valve body 6 being subjected to an operating pressure which is smaller than a restoring force of the or a return element 11. Consequently, the valve body 6 remains held by the return element 11 in this stable switching position.

As a result of the substantially same-sized configuration of the impact surfaces 26 and 27, in all embodiments shown the force which has to be applied to the push-button 10 in order to move the control element 18 from the starting position thereof or upper position in a downward direction is practically independent of an operating pressure which is applied. Consequently, an actuation at high pressures of, for example, over 6 bar is also readily possible.

FIG. 19 shows a damping unit 28 which damps an adjustment movement of the valve body from the first, upper position according to FIG. 18 into the second, lower position according to FIG. 19.

To this end, the damping unit 28 has a flow obstacle 29 in the pressure chamber 14. If the valve body 6 is moved downward, the pressure chamber 14 opens and water flows in. This water first produces a downwardly directed force by means of which the valve body 6 is accelerated in a downward direction.

However, this water strikes the flow obstacle 29 which leads to a braking of the valve body 6. Consequently, the adjustment movement into the lower position is damped.

In this instance, the flow obstacle 29 is in the form by way of example of a circumferential collar on the control element 18. This collar further also supports the damping element 12.

In other embodiments, the damping unit 28 has alternatively or additionally to the flow obstacle at least one element, preferably a plurality of elements, from the list of displacement dampers, spring dampers, mechanical friction dampers.

The damping unit 28 may also be constructed as in the previous embodiments.

The invention thus relates in particular to a diversion apparatus 1, in particular for a sanitary fitting 100, comprising a housing 2 which forms a valve body space 23 having at least one inlet opening 3 and at least two outlet openings 4, 5, wherein there is displaceably guided within the valve body space 23 a valve body 6 by means of which a throughflow path 7, 8 can be diverted between the at least two outlet openings 4, 5, wherein the valve body 6 can be adjusted by means of an adjustment mechanism 9, wherein the adjustment mechanism 9 is operationally connected to an operating element which is in the form of a push-button 10, wherein an operational connection can be configured between the adjustment mechanism and the push-button.

List of Reference Numerals

1 Diversion apparatus

2 Housing

3 Inlet opening

4 First outlet opening

5 Second outlet opening

6 Valve body

7 First throughflow path

8 Second throughflow path

9 Adjustment mechanism

10 Push-button

11 Return element

12 Damping element

13 Sealing element

14 First throughflow chamber

15 Second throughflow chamber

16 Sealing element

17 Push-push adjustment mechanism

18 Control element

19 Mechanical interface

20 Coupling element

21 Counter-coupling element

22 Ventilation channel

23 Valve body space

24 Upper impact surface of 14

25 Lower impact surface of 14

26 Upper impact surface of 15

27 Lower impact surface of 15

28 Damping unit

29 Flow obstacle

30 Sleeve

31 Switching element

32 Guide path

1. A diversion apparatus (1), comprising:
a housing (2) having at least one inlet opening (3) and at least two outlet openings (4, 5);
a valve body (6) configured to divert a throughflow path (7, 8) between the at least two outlet openings (4, 5);
an adjustment mechanism (9) configured to adjust the valve body (6), the adjustment mechanism (9) is operationally connected or connectable to an operating element comprising a push-button (10);
the valve body (6) separates a first throughflow chamber (14) from a second throughflow chamber (15) and wherein at least one of a) the first throughflow chamber and the second throughflow chamber (14, 15) are limited by the valve body (6) in an adjustment direction thereof by impact surfaces (24, 25, 26, 27) substantially of a same size or b) the one of the first or second throughflow chambers (15) at that end of the valve body (6) which is remote from the push-button (10) is limited by the valve body (6) in the adjustment direction thereof by the impact surfaces (26, 27) having substantially of the same size; and
a return element (11) is arranged between the push-button (10) and the housing (2) and is supported on the push-button (10) and on the housing (2).

2. The diversion apparatus (1) as claimed in claim 1, wherein the push-button (10) is securely connected to at least one of the adjustment mechanism (9) a control element (18) so that the push-button (10) is rigidly coupled to the valve body (6).

3. The diversion apparatus (1) as claimed in claim 1, wherein the push-button (10) is initially uncoupled from at least one of the adjustment mechanism (9) or from a control element (18) during a switching operation and is subsequently coupled to the at least one of the adjustment mechanism (9) or the control element (18).

4. The diversion apparatus (1) as claimed in claim 1, wherein the adjustment mechanism (9) is configured for a monostable adjustment of the valve body (6), such that, with a pressure acting on the inlet opening (3), a stable adjustment of the valve body (6) from a first position into a second position is possible and in the event of a pressure decrease at the inlet opening (3), a return of the valve body (6) from the second position into the first position occurs.

5. The diversion apparatus (1) as claimed in claim 1, wherein the adjustment mechanism (9) is configured for a bistable adjustment of the valve body (6), such that, regardless of a pressure acting at the inlet opening (3), the valve body (6) is adjustable in a stable manner in a desired position of at least two positions.

6. The diversion apparatus (1) as claimed in claim 1, wherein at least one of a) the push-button (10) is extended in a first position and is pressed-in in a second position, or b) by applying a pressing force to the push-button (10) a diversion of the valve body (6) at least from the first position into the second position is carried out.

7. The diversion apparatus (1) as claimed in claim 1, further comprising at least one return element (11) which is arranged such that a restoring force produced thereby counteracts a pressure activation of the push-button (10) by the return element (11) being compressed in a pressed-in position of the push-button (10).

8. The diversion apparatus (1) as claimed in claim 1, further comprising at least one damping element (12) which at least one of a) produces a damping force which, when the valve body (16) is returned from the second position into the first position, counteracts an adjustment force, or b) acts in a pressing force which is applyable by the push-button (10), such that a sealing element (13) is acted on in order to be retained at an intended.

9. The diversion apparatus (1) as claimed in claim 1, wherein in a first position the first throughflow chamber (14) is connected to the inlet opening (3) and wherein in a second position the second throughflow chamber (15) is connected to the inlet opening (3), and a separation is configured by at least one sealing element (16).

10. The diversion apparatus (1) as claimed in claim 1, wherein at least one of a) the first throughflow chamber (14) is limited by the valve body (6) in an adjustment direction thereof by surfaces (24, 25) of different sizes, so that the first throughflow chamber (14) is kept open by an operating pressure, or b) the second throughflow chamber is limited by the valve body (6) in the adjustment direction thereof by the impact surfaces (26, 27) substantially of a same size, such that a resultant actuation force of the valve body (6) is smaller than a restoring force of the return element (11).

11. The diversion apparatus (1) as claimed in claim 1, wherein the valve body (6) is engageable in a stable manner in a first position and in a second position by the adjustment mechanism (9), which comprises at least one of a push-push adjustment mechanism (17) or a rotating switching element (18).

12. The diversion apparatus (1) as claimed in claim 1, wherein the adjustment mechanism (9) has a stable switching position and an unstable switching position, and a return element (11) moves the adjustment mechanism from the unstable switching position to the stable switching position.

13. The diversion apparatus (1) as claimed in claim 1, wherein the valve body (6) is operationally connected to the push-button (10) by a control element (18), and the valve body (6) and the control element (18) are constructed in one piece.

14. A series of diversion apparatuses (1), comprising at least one monostable variant, which forms a monostable diversion apparatus (1), and at least one bistable variant which forms a bistable diversion apparatus (1), and the monostable variant and the bistable variant define a uniform mechanical interface (19) for a receiving sanitary fitting (100).

15. A series of diversion apparatuses (1), comprising at least one long variant which forms a monostable diversion apparatus (1), and at least one short variant which forms a monostable diversion apparatus (1), wherein the long variant and the short variant define a uniform mechanical interface (19) for a receiving sanitary fitting (100) and, in the long variant, a portion which protrudes over the interface (19) is larger than in the short variant.

16. (canceled)

17. (canceled)

18. The series as claimed in claim 15, wherein the at least two diversion apparatuses (1) have structurally identical coupling locations (20) in order to be able to be selectively coupled to a corresponding counter-coupling location (21) of a fitting (100).

19. The diversion apparatus (1) as claimed in claim 1, further comprising at least one damping unit (28) by which an adjustment movement of the valve body (6) from a first position into a second position is damped, the damping unit (28) comprising a flow obstacle (29) in an opening pressure chamber (14).
